(19) United States
(12) Patent Application Publication
(10) Pub. No.: US 2011/0030811 A1
(43) Pub. Date: Feb. 10, 2011

(54) PREHEATING BACKWATER DEVICE

(76) Inventor: Po-Hsiang HSU, Hsinchu City (TW)

Correspondence Address: RABIN & Berdo, PC, 1101 14TH STREET, NW, SUITE 500, WASHINGTON, DC, 20005, US

(21) Appl. No.: 12/535,910

(22) Filed: Aug. 5, 2009

(51) Int. Cl. F16L 53/00

(52) U.S. Cl. 137/334

(57) ABSTRACT

The utility model provides a preheating backwater device, comprising: a tank body, a pump, a control module, a Y-pipe, a first joint pipe, a second joint pipe, a third joint pipe and fourth joint pipe. The device is installed with a hot-water heater and existing hot water tubes and water supply tubes in a building. Users can press wire linked buttons or use wireless remote control first before the hot water is used to turn on the preheating backwater device and pump out the possibly cooled or low temperature water in the hot water tubes by the device so that the water re-circulates to the hot-water heater for heating. It lasts for a recirculation of about several tens of seconds to several minutes and till the time set-up in advance. Users only need to turn the faucet to the hot water mark and hot water will be available. At this moment, preheating of the water stops.

### FIELD OF THE INVENTION

The utility model is to provide a preheating backwater device, comprising a tank body, a pump, a control module, a Y-pipe, a first joint pipe, a second joint pipe, a third joint pipe and a fourth joint pipe and being installed with a hot-water heater and existing hot water tubes and water supply tubes in a building. Users can set up time (about several tens of seconds to several minutes) for the control module according to actual demands and the tube length in a building. Users can press wire linked buttons or use wireless remote control first to turn on the preheating backwater device. Then, water in the hot water tubes is pumped out and recirculated to the hot-water heater for heating by the device. The water keeps running in the circulation till the time set-up in advance. Users only need to turn the faucet to the hot water mark and hot water will be available.

### BACKGROUND OF THE INVENTION

When people turn the faucet to use hot water, cold water in the tube will flow out via the faucet in the beginning. Hot water flows out after several minutes. The water that has flowed out before the hot water starts flowing will be wasted.

Based on a family having an average of 3.3 persons, according to the way people traditionally use hot-water heater, 100 liter of water is lost just waiting for the cold water flowing out to turn hot. A family looses 36,500-liters of water every year. According to the applicant's country which has 7.5 million families, a total 68,437,500,000 gallons of water per year are lost. Namely, 187,500,000 gallons of water per day are lost. This exacerbates the greenhouse effect.

Furthermore, according to the announcement from the annual convention of world population held in Tours, France, the world's population had been over 6.5 billions by June 2005. Based on the traditional way people use hot-water heater, everyone wastes 33.3 liters of cold water by turning on the faucet to wait for hot water every day. If it is calculated based on the global population, a shocking 54,112,500,000 gallons of water are wasted a day.

It is a worldwide trend for every country to focus on economy, disadvantaged minority, power consumption and education. The utility model is invented following this trend, especially in use of energy. It can save the wasted resources and reutilizes them. The utility can help to prosper the economy as well.

Therefore, some manufacturers have developed a fixed time and constant temperature backwater device, comprising a timer, an automatic temperature detector, an uninterruptible power supply, a pressure relief valve and a pressure barrel. Users can set up time to recirculate water via the aforementioned units based on demands. The backwater device will start to heat the backwater according to the set-up time. However, when users are not able to use hot water immediately, the backwater device still operates according to the set-up time so as to cause inconvenience that set-up time doesn't match the real time people use hot water. Hence, gas and electric power are wasted. It can not save gas and electric, and even worse, it may even cause users to worry about the hot-water heater to burn up without warning.

Furthermore, inner diameters of the kind of backwater device are usually smaller with more windings and not compatible with that of the tubes in the building. It is easy to cause insufficient water pressure and low water flow under this situation.

Therefore, due to the aforementioned situations, based on the related design, development and manufacturing experiences for years, the inventor worked very hard to achieve this utility model.

### SUMMARY OF THE INVENTION

The main object of the invention is to pump out the water in hot water tubes and send it to a hot-water heater to heat again by a backwater device composed of a tank body, a pump, a control module, a Y-pipe, a first joint pipe, a second joint pipe, a third joint pipe and a fourth joint pipe with a hot-water heater, existing hot water tubes and water supply tubes in a building for users to remote control a pump of a preheating backwater device via the control module in advance before the faucet is opened to use hot water. Then, the water flows into a hot water tubes via a hot water outlet of the hot-water heater. Recirculation repeats (about several tens of seconds to several minutes) until the set-up time. Hot water is available for users.

Another major goal of the present invention is to save water, electricity, gas and time with the device in case of waste of resources. It eases users' uncomfortable feeling about continual heating of the hot-water heater or other heating devices, such as an instant electric water heater, a gas heater, an electrical/gas storage hot-water heater or a boiler.

A minor goal of the present invention is that the device gets rid of the pressure barrel, timer, automatic temperature detector, uninterruptible power supply, and pressure relief valve in a traditional backwater device to save cost of the preheating backwater device.

A minor goal of the present invention is that the inner diameter of the device is enlarged, the bending portions are straightened and the length is reduced. Therefore, water is able to flow smoothly away and allow quick heating.

### BRIEF DESCRIPTION OF THE DRAWING

FIG. 1 is a front view of the inner structure of the present invention.

FIG. 2 shows an embodiment of the present invention.

### DETAILED DESCRIPTION OF THE PREFERRED EMBODIMENTS

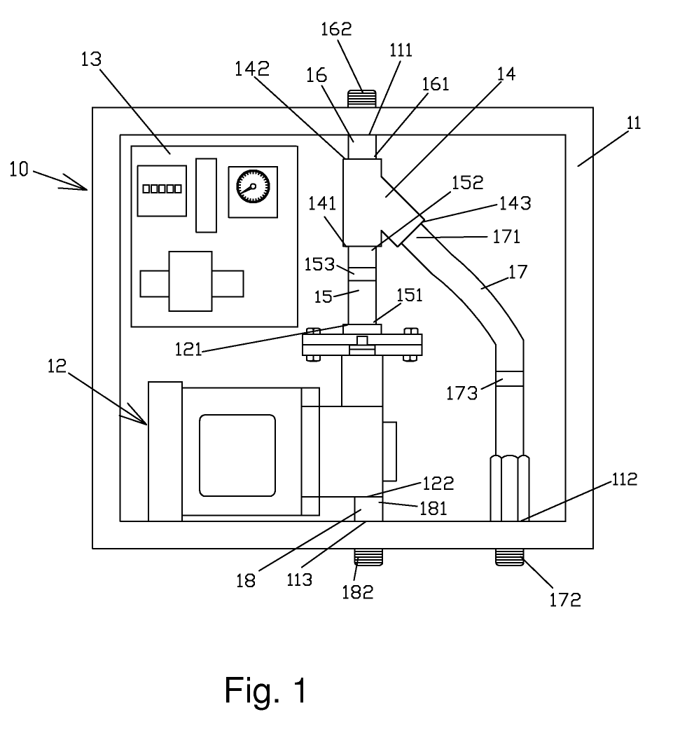

Please refer to FIG. 1. A preheating backwater device (10) is composed of a tank body (11), a pump, a control module (13), a Y-pipe (14), a first joint pipe (15), a second joint pipe (16), a third joint pipe (17) and a fourth joint pipe (18). The pump (12) is formed integrally. The Y-pipe (14) can reduce decompression of water flow.

An interface (111) is on a proper place of the inner top surface of the tank body (11). Two interfaces (112) (113) are on proper places of the inner bottom surface of the tank body (11). The pump (12) is installed on a proper place of the inner bottom surface of the tank body (11) and doesn't block the two interfaces (112) (113). The control module (13) is installed on the inner back surface of the tank body (11) and connected with the pump (12) so that the pump (12) can be controlled to drive. The automatic control module (13) can set up time and control the pump to start and stop.

Connect a nozzle (151) in one end of the first joint pipe (15) with an outlet (121) of the pump (12) for fixing so that the first joint pipe (15) is connected to the outlet (121) of the pump (12). The other nozzle (152) in the other end of the first joint pipe (15) is connected with a first interface (141) of the Y-pipe (14) for fixing, wherein a backwater gate (153) is installed in the first joint pipe (15).

Connect a nozzle (161) in one end of the second joint pipe (16) with a corresponding second interface (142) of the Y-pipe (14) and fix them. The other nozzle (162) in the other end of the second joint pipe (16) is connected with the corresponding interface (111) of the tank body (11) and fixed.

Connect a nozzle (171) in one end of the third joint pipe (17) with a corresponding third interface (143) of the Y-pipe (14) and fix them. The other nozzle (172) in the other end of the third joint pipe (17) is connected with the corresponding interface (112) of the tank body (11) and fixed, wherein a backwater gate (173) is installed in the third joint pipe (17).

Connect a nozzle (181) in one end of the fourth joint pipe (18) with a corresponding intake (122) of the pump (12) and fix them. The other nozzle (182) in the other end of the fourth joint pipe (18) is connected with the corresponding interface (113) of the tank body (11) and fixed. Assembly of the preheating backwater device (10) is completed.

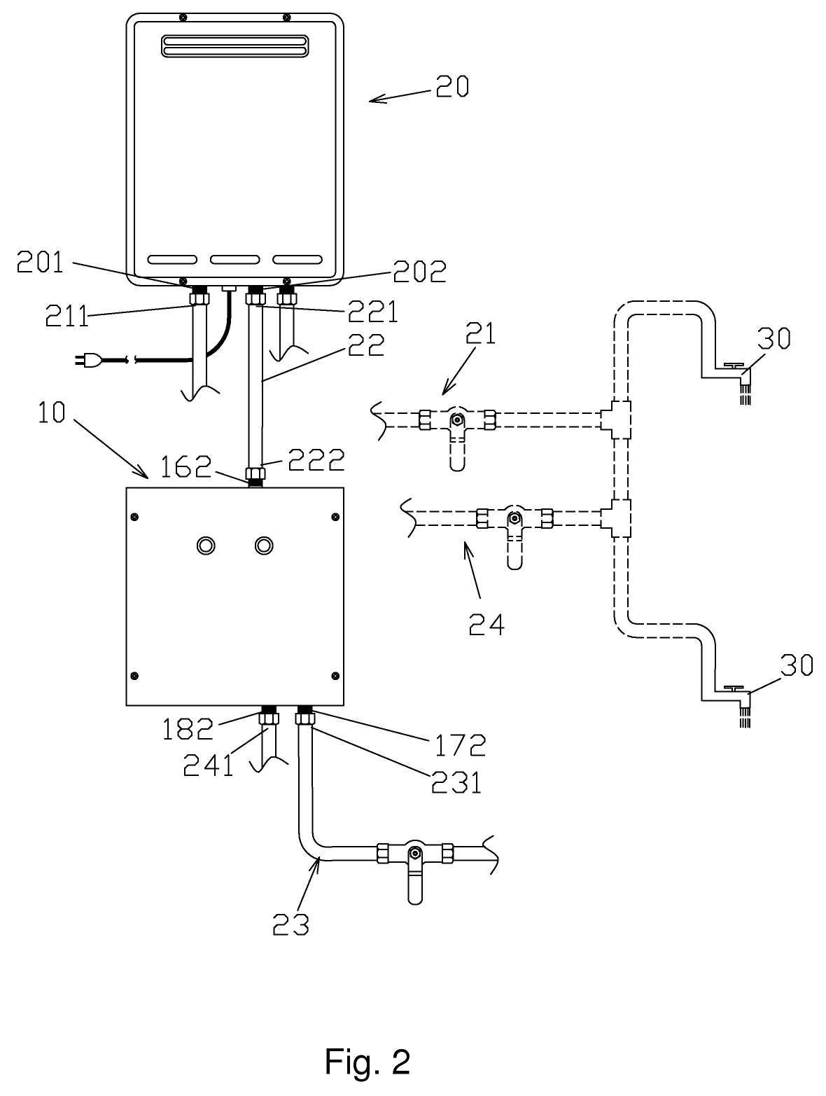

Please refer to FIG. 2. a building has already been fabricated with hot water tubes (21) and is arranged with another backwater tube (24). The preheating backwater device (10) is installed in where a hot-water heater (20) has existed in advance, wherein an intake (211) of the set-up hot water tubes (21) in the building is connected to a hot water exit (201) of the hot-water heater (20). One nozzle (221) of the joint pipe (22) which is linked to ajoint pipe (23) is connected to a water supply interface (202) of the hot-water heater (20). The other nozzle (222) of the joint pipe (22) is connected to a nozzle (162) the backwater device (10).

An outlet (231) of the set-up water supply tubes (23) in the building is connected with the nozzle (172) of the backwater device (10) firmly. At last, connect an interface (241) of the backwater tube (24) with the nozzle (182) of the preheating backwater device (10). According to site situation and user demands, set up time for the control module (13) of the preheating backwater device (10). The preheating backwater device (10), the hot-water heater (20) and the current hot water tubes (21) and water supply tubes (23) in the building are assembled.

If users want to use hot water to talk a shower, it is not necessary to turn on the faucet (30) before taking off clothes. All you have to do is manually press the switch installed in a proper place in a building in advance or turn on the switch with a remote control, the pump (12) of the preheating backwater device (10) will operate. The pump (12) will pump out the water in the hot water tubes (21) and send it to the hot-water heater (20) for heating via the fourth joint pipe (18), the first joint pipe (15) and the second joint pipe (16), wherein the backwater gate (173) of the third joint pipe (17) will close to prevent water flowing back from the third joint pipe (17) to the water supply tubes (23) by accident when the pump (12) is pumping. On the contrary, the backwater gate (153) of the first joint pipe (15) will open.

Next, the water flows to the hot water tubes (21) via a hot water outlet (201) of the hot-water heater (20) to be re-circulated. The status will be maintained until the set-up time. Now, users turn on the faucet (30) and can use hot water immediately.

The preheating backwater device (10) is not only used with the hot-water heater (20), but also other heating equipments, such as an instant electric water heater, a gas heater, an electrical/gas storage hot-water heater or a boiler. They both have an effect of preheating backwater.

What is claimed is:

1. A preheating backwater device, comprising: a tank body, a pump, an automatic control module, a Y-pipe, a first joint pipe, a second joint pipe, a third joint pipe and a fourth joint pipe, wherein the pump and the automatic control module are connected and fabricated inside the tank body, one nozzle of the first joint pipe is connected to an outlet of a pump while the other nozzle is connected to a first interface of the Y-pipe, one nozzle of the second joint pipe is connected to a second interface of the Y-pipe while the other nozzle is connected to an interface of the tank body, one nozzle of the third joint pipe is connected to a third interface of the Y-pipe while the other nozzle is connected to an interface of the tank body, one nozzle of the fourth joint pipe is connected to an intake of the pump while the other nozzle is connected to an interface of the tank body and the backwater device is assembled thereby.

2. The preheating backwater device according to claim 1, wherein the automatic control module is connected to a switch fabricated in a building in advance so that users can turn on the switch by manual control or remote control.

3. The preheating backwater device according to claim 1, wherein the pump is formed integrally including a lower intake and an upper outlet.

4. The preheating backwater device according to claim 1, wherein the preheating backwater device can be installed inside a hot-water heater to form a unity.
